(19) United States
(12) Patent Application Publication
(10) Pub. No.: US 2023/0131420 A1
(43) Pub. Date: Apr. 27, 2023

(54) MASTERBATCH MANUFACTURING METHOD AND TIRE MANUFACTURING METHOD

(71) Applicant: Toyo Tire Corporation, Itami-shi (JP)

(72) Inventor: Asuka Noda, Itami-shi (JP)

(73) Assignee: Toyo Tire Corporation, Itami-shi (JP)

(21) Appl. No.: 17/960,298

(22) Filed: Oct. 5, 2022

(30) Foreign Application Priority Data
Oct. 22, 2021 (JP) 2021-172820

(51) Int. Cl. C08J 3/22; C08K 3/04; B60C 1/00

(52) U.S. Cl. CPC C08J 3/22; C08K 3/04; B60C 1/00; C08J 2307/02

(57) ABSTRACT

A masterbatch manufacturing method comprises: an operation in which carbon black is dispersed in dispersion medium in presence of a surface active agent having an aromatic ring to prepare a carbon black slurry; an operation in which at least the carbon black slurry and a rubber latex are mixed to prepare a liquid mixture; and an operation in which the liquid mixture is coagulated.

### TECHNICAL FIELD

The present invention relates to a masterbatch manufacturing method and a tire manufacturing method.

### BACKGROUND ART

With rubber products such as pneumatic tires, it is possible by improving carbon black dispersion characteristics to improve a property of vulcanized rubber; i.e., ability to achieve reduced heat generation. By using a masterbatch in which carbon black is dispersed to fabricate rubber products, carbon black dispersion characteristics permit improvement thereof. Masterbatch might, for example, be prepared through employment of a procedure in which rubber latex and a carbon black slurry are mixed, and this is coagulated.

Patent Reference No. 1 contains a description to the effect that it may be theoretically possible to improve carbon black dispersion by adding surface active agent to the carbon black slurry at the time that the masterbatch is being prepared.

### PRIOR ART REFERENCES

### Patent References

Patent Reference No. 1: Japanese Patent Application Publication Kokai No. 2016-175980

### SUMMARY OF INVENTION

### Problem to be Solved by Invention

However, because Patent Reference No. 1 does not actually describe that surface active agent was added to carbon black slurry, that the dispersion characteristics of carbon black might be improved as a result of addition of surface active agent is not supported thereby. And that the properties of vulcanized rubber might be improved as a result of addition of surface active agent is, of course, not supported thereby.

It is an object of the present invention to provide a method for manufacturing a masterbatch such as will serve as raw material for vulcanized rubber having excellent rupture strength and ability to achieve reduced heat generation. In addition, it is an object of the present invention to provide a method for manufacturing a tire that employs masterbatch manufactured by that manufacturing method. Here, “rupture strength” is synonymous with tensile strength. More specifically, “rupture strength” is defined as the value of the maximum tensile force recorded when vulcanized rubber (e.g., a test piece cut from vulcanized rubber) is elongated until breakage occurs divided by the cross-sectional area of the vulcanized rubber prior to testing.

### Means for Solving Problem

A masterbatch manufacturing method in accordance with the present invention, which is one means for solving such problem(s), comprises an operation in which carbon black is dispersed in dispersion medium in presence of a surface active agent having an aromatic ring to prepare a carbon black slurry;

an operation in which at least the carbon black slurry and a rubber latex are mixed to prepare a liquid mixture; and

an operation in which the liquid mixture is coagulated.

Here, “dispersion medium” means a liquid that contains water. The dispersion medium might be pure water, or might be tap water, or might be water which contains reagent(s) and/or organic solvent(s), for example.

In preparing the carbon black slurry, a masterbatch manufacturing method in accordance with the present invention may be such that because the carbon black is dispersed in dispersion medium in the presence of a surface active agent, it is possible to cause the carbon black to be dispersed therein to a high degree.

Moreover, because the surface active agent has aromatic ring(s), this may make it possible to cause the carbon black to be dispersed to an even higher degree. This is thought to be due to the fact that the aromatic ring(s) of the surface active agent interact with surface functional group(s) of the carbon black, and that this causes the surface active agent to be effectively adsorbed by the carbon black.

Because a procedure is adopted in which such a carbon black slurry and a rubber latex are mixed, and a liquid mixture is coagulated, it is possible to fabricate a coagulum, i.e., crumb, in which carbon black is dispersed to a high degree. That is, it is possible to reduce variation in the amount of carbon black (hereinafter sometimes referred to as “the amount incorporated thereinto”) from one piece of crumb to another. As a result, it will be possible to improve the rupture strength and ability to achieve reduced heat generation of the vulcanized rubber. In addition, it will be possible to reduce the amount of time required to cause carbon black to be dispersed to a given degree (hereinafter sometimes referred to as “the carbon black slurry processing time”).

It is preferred that the constitution be such that the aromatic ring is one among a plurality of intramolecular aromatic rings possessed by the surface active agent.

As a result of adoption of such a constitution, it will be possible to even further improve the rupture strength and ability to achieve reduced heat generation of the vulcanized rubber. This is thought to be due to the fact because the surface active agent has a plurality of aromatic rings, this causes the surface active agent to be all the more effectively adsorbed by carbon black.

It is preferred that the constitution be such that the surface active agent is the sodium salt of the β-naphthalene sulfonic acid-formaldehyde condensate.

As a result of adoption of such a constitution, it will be possible to even further improve the rupture strength and ability to achieve reduced heat generation of the vulcanized rubber. This is thought to be due to the fact because the sodium salt of the β-naphthalene sulfonic acid-formaldehyde condensate has a plurality of naphthalene rings, this causes it to be all the more effectively adsorbed by carbon black.

A tire manufacturing method in accordance with the present invention comprises

an operation in which a masterbatch is prepared in accordance with a manufacturing method as described above;

an operation in which the masterbatch is used to prepare a rubber composition;

and an operation in which the rubber composition is used to prepare an unvulcanized tire.

### EMBODIMENTS FOR CARRYING OUT INVENTION

Below, description is given with respect to embodiments of the present invention.

### 1. Masterbatch Manufacturing Method

A masterbatch manufacturing method in accordance with the present embodiment comprises an operation (hereinafter sometimes referred to as “Operation A”) in which a carbon black slurry is prepared, an operation (hereinafter sometimes referred to as “Operation B”) in which at least the carbon black slurry and a rubber latex are mixed to prepare a liquid mixture, and an operation (hereinafter sometimes referred to as “Operation C”) in which the liquid mixture is coagulated. Because it comprises these operations, a masterbatch manufacturing method in accordance with the present embodiment may be capable of fabricating a coagulum, i.e., crumb, in which carbon black is dispersed to a high degree. That is, it is possible to reduce variation in the amount of carbon black (i.e., the amount incorporated thereinto) from one piece of crumb to another. As a result, it will be possible to improve the rupture strength and ability to achieve reduced heat generation of the vulcanized rubber. In addition, it will be possible to reduce the amount of time required to cause carbon black to be dispersed to a given degree (i.e., the carbon black slurry processing time). A masterbatch manufacturing method in accordance with the present embodiment may further comprise an operation (hereinafter sometimes referred to as “Operation D”) in which the coagulum is dewatered.

1.1 Operation a (Operation in which Carbon Black Slurry is Prepared)

At Operation A, carbon black is dispersed in dispersion medium in the presence of a surface active agent having aromatic ring(s) to prepare a carbon black slurry. Although carbon black is hydrophobic, because the carbon black is dispersed in dispersion medium in the presence of a surface active agent, it is possible to cause the carbon black to be dispersed therein to a high degree.

A carbon black slurry may be prepared through employment of a procedure in which surface active agent and carbon black are added to dispersion medium, and this is agitated. Or instead of this procedure, this may be prepared through employment of a procedure in which carbon black is added to dispersion medium after the surface active agent has been added thereto and/or dispersed therein, and this is agitated. Or the carbon black slurry may be prepared through employment of a procedure in which surface active agent is added to dispersion medium after the carbon black has been added thereto and/or dispersed therein, and this is agitated. During agitation, a disperser—e.g., a high-shear mixer, homomixer, ball mill, bead mill, high-pressure homogenizer, ultrasonic homogenizer, colloid mill, and/or the like—may be used.

The surface active agent has aromatic ring(s). More specifically, the surface active agent has intramolecular aromatic ring(s). Because the surface active agent has aromatic ring(s), this makes it possible to cause the carbon black to be dispersed to an even higher degree. This is thought to be due to the fact that the aromatic ring(s) of the surface active agent interact with surface functional group(s) of the carbon black, and that this causes the surface active agent to be effectively adsorbed by the carbon black. As aromatic ring(s), benzene ring(s), naphthalene ring(s), anthracene ring(s), and the like may be cited as examples. Of these, naphthalene ring(s) and anthracene ring(s) are preferred, and naphthalene ring(s) are more preferred. Causing the surface active agent to have intramolecular fused ring(s) in the form of naphthalene ring(s) and/or anthracene ring(s) will make it possible to even further improve rupture strength and/or ability to achieve reduced heat generation in vulcanized rubber. This is thought to be due to the fact where the surface active agent has fused ring(s), this causes the surface active agent to be all the more effectively adsorbed by carbon black.

It is preferred that the surface active agent have a plurality of intramolecular aromatic rings. Where it is said here that “the surface active agent should have a plurality of intramolecular aromatic rings,” note that when the aromatic ring is a fused ring in the form of a naphthalene ring or an anthracene ring, the fused ring will be counted as a single ring. Where, for example, a surface active agent has just one intramolecular naphthalene ring, it would be judged that such a surface active agent has one intramolecular aromatic ring. That is, such a surface active agent would not be judged to have a plurality of intramolecular aromatic rings. Causing the surface active agent to have a plurality of intramolecular aromatic rings will make it possible to even further improve rupture strength and/or ability to achieve reduced heat generation in vulcanized rubber. This is thought to be due to the fact where the surface active agent has a plurality of aromatic rings, this causes the surface active agent to be all the more effectively adsorbed by carbon black.

So long as the surface active agent has aromatic ring(s), there is no particular limitation with regard to the type of surface active agent(s) employed. As type(s) of surface active agent, negative ion surface active agents (i.e., anionic surface active agents), positive ion surface active agents (i.e., cationic surface active agents), zwitterionic surface active agents, and nonionic surface active agents may be cited as examples. Of these, anionic surface active agents are preferred.

Thereamong, as surface active agent, the sodium salt of the β-naphthalene sulfonic acid-formaldehyde condensate is preferred. Causing the surface active agent to be the sodium salt of the β-naphthalene sulfonic acid-formaldehyde condensate will make it possible to even further improve rupture strength and/or ability to achieve reduced heat generation in vulcanized rubber. This is thought to be due to the fact because the sodium salt of the β-naphthalene sulfonic acid-formaldehyde condensate has a plurality of naphthalene rings, this causes it to be all the more effectively adsorbed by carbon black. As the sodium salt of the β-naphthalene sulfonic acid-formaldehyde condensate, note for example that “Demol NL” is commercially available from Kao Corporation.

For every 100 parts by mass of dispersion medium, it is preferred that the amount of surface active agent be not less than 0.1 part by mass, and more preferred that this be not less than 0.5 part by mass. For every 100 parts by mass of dispersion medium, it is preferred that the amount of surface active agent be not greater than 5 parts by mass, and more preferred that this be not greater than 2 parts by mass.

The dispersion medium is a liquid that contains water. The dispersion medium might be pure water, or might be tap water, or might be water which contains reagent(s) and/or organic solvent(s), for example. The dispersion medium may contain particles and/or the like.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

It is preferred that the amount of carbon black be not less than 1 mass %, more preferred that this be not less than 2 mass %, and still more preferred that this be not less than 3 mass %, per 100 mass % of the carbon black slurry. It is preferred that the amount of carbon black in the carbon black slurry be not greater than 30 mass %, more preferred that this be not greater than 25 mass %, still more preferred that this be not greater than 20 mass %, still more preferred that this be not greater than 15 mass %, and still more preferred that this be not greater than 10 mass %, per 100 mass % of the carbon black slurry.

The carbon black slurry may contain surface active agent, dispersion medium, and/or carbon black. At the carbon black slurry, carbon black may be dispersed in dispersion medium.

Regarding the carbon black slurry, the D90 value of carbon black, i.e., the (volume-based) particle diameter corresponding to 90% at the integrated particle diameter distribution, may be employed as index of carbon black dispersion characteristics. Whereas the smaller the D90 value the higher will be the degree to which the carbon black is dispersed, it is preferred that the D90 value thereof be not greater than 6.0 μm, more preferred that this be not greater than 4.0 μm, and still more preferred that this be not greater than 3.0 μm. For example, the D90 value thereof might be not less than 0.5 μm, or might be not less than 1.0 μm. The D90 value is the value as measured by the method described in the Working Examples, below.

1.2. Operation B (Operation in which Liquid Mixture is Prepared)

At Operation B, at least a carbon black slurry and rubber latex are mixed to prepare a liquid mixture. During such mixing, a disperser—e.g., a high-shear mixer, homomixer, ball mill, bead mill, high-pressure homogenizer, ultrasonic homogenizer, colloid mill, and/or the like—may be used.

As rubber latex, diene rubber latex is preferred. Diene rubber latex is rubber latex that contains diene rubber particles (hereinafter sometimes referred to simply as “rubber particles”) At the diene rubber latex, diene rubber particles may be dispersed in colloidal fashion in dispersion medium. More specifically, at the diene rubber latex, diene rubber particles may be dispersed in colloidal fashion in water. The diene rubber latex may contain organic solvent. Thus, the dispersion medium might, for example, be water that contains organic solvent. Moreover, the diene rubber may have unsaturated hydrocarbon bond(s) at the main chain, and preferably has carbon-carbon double bond(s) thereat.

As diene rubber latex, natural rubber latex and synthetic rubber latex may be cited as examples. Of these, natural rubber latex is preferred.

As natural rubber latex, concentrated natural rubber latex and field latex may be cited as examples. In the natural rubber latex, rubber particles may be dispersed in colloidal fashion in dispersion medium. More specifically, in the natural rubber latex, rubber particles may be dispersed in colloidal fashion in water. The natural rubber latex may contain organic solvent. Thus, the dispersion medium might, for example, be water that contains organic solvent.

It is preferred that dry rubber content of the rubber latex be not less than 10 mass %, and more preferred that this be not less than 20 mass %. The upper limit of the range in values for the dry rubber content of the rubber latex might, for example, be 60 mass % or 50 mass %.

Mixture of the carbon black slurry and rubber latex may be carried out so as to preferably cause there to be not less than 1 part by mass, more preferably not less than 5 parts by mass, and still more preferably not less than 10 parts by mass, of carbon black per 100 parts by mass of dry rubber content in the natural rubber latex. Such mixture may be carried out so as to preferably cause there to be not greater than 80 parts by mass, more preferably not greater than 60 parts by mass, and still more preferably not greater than 40 parts by mass, of carbon black per 100 parts by mass of dry rubber content in the natural rubber latex.

1.3. Operation C (Operation in which Liquid Mixture is Coagulated)

At Operation C, the liquid mixture is coagulated. That is, the carbon black and rubber particles within the liquid mixture are made to mutually coagulate. To cause coagulation of the liquid mixture, coagulant may be added to the liquid mixture. The coagulant might, for example, be an acid. As acid, formic acid, sulfuric acid, and the like may be cited as examples. Addition of coagulant may be carried out while agitating the liquid mixture, may be carried out while heating the liquid mixture, or may be carried out in state(s) constituting any desired combination thereof (i.e., agitation and/or heating). Of course, the liquid mixture may be coagulated without use of coagulant.

Following coagulation, the coagulum may be separated from waste liquid as necessary. The coagulum might, for example, take the form of small pieces. Note that coagulum in the form of small pieces is sometimes referred to as “crumbs.” A filter might, for example, be employed to separate coagulum from waste liquid.

1.4. Operation D (Operation in which Coagulum is Dewatered)

At Operation D, the coagulum is dewatered. An extruder, oven, vacuum dryer, and/or air dryer might, for example, be used to dewater the coagulum. Of these, an extruder is preferred. Use of an extruder will make it possible to dewater the coagulum through compaction and/or other effects, and will make it possible to cause the dewatered coagulum to be plasticized as it is dried. As the extruder, a single-screw extruder may be cited as an example.

### 1.5. Other Operations

The extruded coagulum, i.e., the dewatered coagulum, may be cut as necessary, and may be compressed and formed into any desired shape (e.g., into bales) as necessary. A pelletizer might, for example, be used to carry out cutting.

The masterbatch thus obtained may take the form of bales. The form taken by the masterbatch is not limited to bales, it being possible for this to take the form of pellets, to take the form of rods, or to take the form of sheets.

The masterbatch comprises a rubber component. The rubber component may comprise natural rubber. The amount of natural rubber might, for example, be not less than 80 mass %, might be not less than 90 mass %, or might be 100 mass %, per 100 mass % of rubber component within the masterbatch.

The masterbatch may comprise carbon black. It is preferred that the amount of carbon black be not less than 1 part by mass, more preferred that this be not less than 5 part by mass, and still more preferred that this be not less than 10 part by mass, per 100 parts by mass of rubber component. It is preferred that the amount of carbon black be not greater than 80 parts by mass, more preferred that this be not greater than 60 parts by mass, and still more preferred that this be not greater than 40 parts by mass, per 100 parts by mass of rubber component.

### 2. Tire Manufacturing Method

A tire manufacturing method in accordance with the present embodiment comprises an operation in which masterbatch is prepared in accordance with a method as described above, an operation in which the masterbatch is used to prepare a rubber composition, and an operation in which the rubber composition is used to prepare an unvulcanized tire.

2.1. Operation in which Masterbatch is Used to Prepare Rubber Composition

This operation (more specifically, an operation in which masterbatch is used to prepare a rubber composition) may comprise kneading at least masterbatch and compounding ingredient(s) to prepare a rubber mixture, and kneading at least the rubber mixture and vulcanizing-type compounding ingredient(s) to obtain a rubber composition.

At this operation, at least masterbatch and compounding ingredient(s) are kneaded to prepare a rubber mixture. As compounding ingredient(s), filler, zinc oxide, stearic acid, wax, antioxidant, silane coupling agent, vulcanizing-type compounding ingredient, and the like may be cited as examples. One or any desired combination may be chosen from thereamong and used as compounding ingredient(s). Note, however, that it is preferred that vulcanizing-type compounding ingredient not be added at this stage. As filler, carbon black, silica, clay, talc, calcium carbonate, magnesium carbonate, aluminum hydroxide, and the like may be cited as examples. One or any desired combination may be chosen from thereamong and used as the filler. Where carbon black is added at this stage, the properties of such carbon black may be the same as or may be different from the properties of carbon black used in the carbon black slurry. For example, the grade of any carbon black which may be added at this stage may be the same as or may be different from the grade of carbon black used in the carbon black slurry, as defined by ASTM (American Society for Testing and Materials). As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant. Other rubber(s) may be kneaded therein together with the masterbatch and compounding ingredient(s). As such rubbers, natural rubber, polyisoprene rubber, styrene-butadiene rubber, nitrile rubber, chloroprene rubber, and the like may be cited as examples. One or any desired combination may be chosen from thereamong and used. Kneading may be carried out using a kneader. As the kneader, internal kneaders, open roll mills, and the like may be cited as examples. As an internal kneader, Banbury mixers, kneaders, and the like may be cited as examples.

At this operation, at least the rubber mixture and vulcanizing-type compounding ingredient(s) are kneaded to obtain a rubber composition. As vulcanizing-type compounding ingredients, sulfur, organic peroxides, and other such vulcanizing agents, vulcanization accelerators, vulcanization accelerator activators, vulcanization retarders, and so forth may be cited as examples. One or any desired combination may be chosen from thereamong and used as the vulcanizing-type compounding ingredient. As sulfur, powdered sulfur, precipitated sulfur, insoluble sulfur, high dispersing sulfur, and the like may be cited as examples. One or any desired combination may be chosen from thereamong and used as the sulfur. As vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited as examples. One or any desired combination may be chosen from thereamong and used as the vulcanization accelerator. Kneading may be carried out using a kneader. As the kneader, internal kneaders, open roll mills, and the like may be cited as examples. As an internal kneader, Banbury mixers, kneaders, and the like may be cited as examples.

The rubber composition comprises rubber component originating from the masterbatch. The amount of rubber component originating from the masterbatch might be not less than 20 mass %, not less than 40 mass %, might be not less than 60 mass %, might be not less than 80 mass %, or might be 100 mass %, per 100 mass % of rubber within the rubber composition, for example.

The rubber composition comprises carbon black. It is preferred that the amount of carbon black be not less than 1 part by mass, more preferred that this be not less than 5 part by mass, and still more preferred that this be not less than 10 part by mass, per 100 parts by mass of rubber in the rubber composition. It is preferred that the amount of carbon black be not greater than 80 parts by mass, more preferred that this be not greater than 60 parts by mass, and still more preferred that this be not greater than 40 parts by mass, per 100 parts by mass of rubber in the rubber composition.

The rubber composition may further comprise zinc oxide, stearic acid, wax, antioxidant, silica, silane coupling agent, sulfur, vulcanization accelerator, surface active agent, and/or the like. The rubber composition may comprise one or any desired combination thereamong. It is preferred that the amount of the sulfur, expressed as equivalent sulfur content, be 0.5 part by mass to 5 parts by mass, per 100 parts by mass of rubber within the rubber composition. It is preferred that the amount of vulcanization accelerator be 0.1 part by mass to 5 parts by mass, per 100 parts by mass of rubber within the rubber composition.

The rubber composition may be used to prepare a tire. More specifically, it is capable of being used in preparing tire member(s) making up a tire. For example, the rubber composition may be used in preparing tread rubber, sidewall rubber, chafer rubber, bead filler rubber, and/or the like. The rubber composition may be used to prepare one or any desired combination among such tire member(s).

2.2. Operation in which Rubber Composition is Used to Prepare Unvulcanized Tire

A tire manufacturing method in accordance with the present embodiment comprises an operation in which a rubber composition is used to prepare an unvulcanized tire. This operation may comprise preparing tire member(s) comprising a rubber composition, and preparing an unvulcanized tire comprising the tire member(s). As tire members, tread rubber, sidewall rubber, chafer, and bead filler may be cited as examples. Of these, tread rubber is preferred.

### 2.3. Other Operations

A tire manufacturing method in accordance with the present embodiment may further comprise an operation in which the unvulcanized tire is vulcanized and molded. The tire obtained in accordance with the method of the present embodiment may be a pneumatic tire.

### 3. Various Modifications May be Made to the Foregoing Embodiment

Various modifications may be made to the foregoing embodiment. For example, modifications which may be made to the foregoing embodiment might include any one or more variations chosen from among the following.

The foregoing embodiment was described with particular specificity in terms of a constitution in which water is used as dispersion medium to prepare a carbon black slurry. The foregoing embodiment is, of course, not limited to such a constitution. For example, dilute rubber latex may be used instead of water. For example, a carbon black slurry may be prepared through employment of a procedure in which surface active agent and carbon black are added to dilute rubber latex, and this is agitated. Or instead of this procedure, this may be prepared through employment of a procedure in which carbon black is added to dilute rubber latex after the surface active agent has been added thereto and/or dispersed therein, and this is agitated. Or the carbon black slurry may be prepared through employment of a procedure in which surface active agent is added to dilute rubber latex after the carbon black has been added thereto and/or dispersed therein, and this is agitated. In the dilute rubber latex, rubber particles may be dispersed in colloidal fashion in water. The water might, for example, be water that contains organic solvent. It is preferred that dry rubber content of the dilute rubber latex be not less than 0.1 mass %, and more preferred that this be not less than 0.3 mass %. It is preferred that the upper limit of the range in values for the dry rubber content be 5 mass %, and more preferred that this be 2 mass %. The dilute rubber latex might, for example, be prepared through employment of a procedure in which natural rubber latex is diluted with water. Synthetic rubber latex may be used instead of natural rubber latex.

The foregoing embodiment was described in terms of a constitution in which masterbatch and compounding ingredient(s) are kneaded to prepare a rubber mixture. However, the foregoing embodiment is not limited to this constitution. For example, the rubber mixture may be deemed to be the masterbatch.

The foregoing embodiment was described in terms of a constitution in which the tire is a pneumatic tire. However, the foregoing embodiment is not limited to this constitution.

### WORKING EXAMPLES

Working examples in accordance with the present invention are described below.

The raw materials and reagents that were used at the Working Examples are indicated below.
Surface Active Agent A “Demol NL” manufactured by Kao Corporation anionic surface active agent sodium salt of β-naphthalene sulfonic acid-formaldehyde condensate
Surface Active Agent B “Emulgen A060” manufactured by Kao Corporation nonionic surface active agent
Natural rubber latex “NR Field Latex” manufactured by Golden Hope
Solid natural rubber Solid rubber obtained by drying “NR Field Latex” manufactured by Golden Hope
Carbon black “Diablack A” manufactured by Mitsubishi Chemical Corporation
Zinc oxide “Zinc Oxide Variety No. 2” manufactured by Mitsui Mining & Smelting Co., Ltd.
Stearic acid “Stearic Acid” manufactured by Nippon Oil & Fats Co., Ltd.
Wax “OZOACE 0355” manufactured by Nippon Seiro Co., Ltd.
Antioxidant A “Santoflex 6 PPD” manufactured by Flexsys
Antioxidant B “NOCRAC 224” manufactured by Ouchi Shinko Chemical Industrial Co., Ltd.
Sulfur “Oil-Treated 150-Mesh Powdered Sulfur” manufactured by Tsurumi Chemical Industry Co., Ltd.
Vulcanization accelerator “Sanceler NS-G” manufactured by Sanshin Chemical Industry Co., Ltd.

### Preparation of Masterbatch at Comparative Example 1

Following addition of carbon black to solid natural rubber, this was kneaded. As a result of this, a masterbatch was obtained.

### Preparation of Masterbatch at Comparative Example 2

Following addition of carbon black and surface active agent to solid natural rubber, this was kneaded. As a result of this, a masterbatch was obtained.

### Preparation of Masterbatch at Comparative Example 3

30 parts by mass of carbon black was added to 100 parts by mass of water, and a ROBO MIX manufactured by PRIMIX Corporation was used to agitate this at normal temperature to prepare a carbon black slurry. Natural rubber latex was added to the carbon black slurry in accordance with the blended amount shown in TABLE 1, and this was agitated at 90° C. in a device called a mixer (SMV-20 Supermixer) manufactured by Kawata Co., Ltd., to obtain a liquid mixture. Formic acid serving as coagulant was added to the liquid mixture in an amount sufficient to achieve a pH of 4 to obtain a coagulum. A Model V-02 screw press manufactured by Suehiro EPM Corporation (squeezer-type single-screw dewatering extruder) was used to dewater the coagulum, and this was discharged at 120° C. In this way, a masterbatch was obtained.

### Preparation of Masterbatch at Working Example 1 and at Comparative Example 4

30 parts by mass of carbon black and 1 part by mass of surface active agent were added to 100 parts by mass of water, and a ROBO MIX manufactured by PRIMIX Corporation was used to agitate this at normal temperature to prepare a carbon black slurry. Natural rubber latex was added to the carbon black slurry in accordance with the blended amount shown in TABLE 1, and this was agitated at 90° C. in a device called a mixer (SMV-20 Supermixer) manufactured by Kawata Co., Ltd., to obtain a liquid mixture. Formic acid serving as coagulant was added to the liquid mixture in an amount sufficient to achieve a pH of 4 to obtain a coagulum. A Model V-02 screw press manufactured by Suehiro EPM Corporation (squeezer-type single-screw dewatering extruder) was used to dewater the coagulum, and this was discharged at 120° C. In this way, a masterbatch was obtained.

### Preparation of Unvulcanized Rubber at the Various Examples

The compounding ingredients except for sulfur and vulcanization accelerator were added to masterbatch in accordance with TABLE 1, and a Banbury mixer was used to carry out kneading (i.e., nonproductive mixing) to obtain a rubber mixture. The rubber mixture was kneaded (i.e., productive mixing was carried out) with sulfur and vulcanization accelerator in a Banbury mixer to obtain unvulcanized rubber.

### Preparation of Vulcanized Rubber

The unvulcanized rubber was vulcanized for 30 minutes at 150° C. to obtain vulcanized rubber.

tan δ

tan δ of vulcanized rubber was measured in accordance with JIS K-6394 2007. More specifically, measurement was carried out using a viscoelasticity testing machine manufactured by Toyo Seiki under conditions of temperature 60° C., frequency 10 Hz, static strain 10%, and dynamic strain 1%. tan δ of the respective Examples are shown at TABLE 1 as indexed relative to a value of 100 for the tan δ obtained at Comparative Example 1. The lower the index the less the tendency for heat generation to occur, and thus the better the ability to achieve reduction in fuel consumption when used as a tire.

### Tensile Strength (i.e., Rupture Strength)

Tensile strength of vulcanized rubber was measured in accordance with JIS K-6251 2017. More specifically, a dumbbell-shaped test piece was cut from vulcanized rubber in the shape of a No. 3 dumbbell, a tensile test apparatus was used to measure the tensile force at the dumbbell-shaped test piece, and the tensile strength (i.e., the value of the maximum tensile force recorded when the test piece is elongated until breakage occurs divided by the cross-sectional area of the test piece prior to testing) was determined. The tensile strengths for the respective Examples are shown at TABLE 1 as indexed relative to a value of 100 for the tensile strength obtained at Comparative Example 1. The higher the index the higher the tensile strength.

### Carbon Black Slurry Particle Size Distribution (D90 Value)

Water was added to the carbon black slurries prepared at Comparative Examples 3 and 4 and Working Example 1 to prepare 0.005 mass % carbon black diluents. A particle size distribution image analyzer (“IF-3200” manufactured by Jasco International Co., Ltd.; “PIA-Pro Image Analysis Software, Ver. 2016” analytic software; measurement conditions: cell thickness=50 μm, sample concentration=0.005 wt %, cumulative number of particles used for analysis=15,000 to 30,000 particles) was used to determine the D90 values of these diluents. That is, the (volume-based) particle diameter corresponding to 90% at the integrated particle diameter distribution was determined. D90 values are shown in TABLE 1 in units of μm.

TABLE 1

| | | | Comparative | Comparative | Comparative | Working | Comparative |
|---|---|---|---|---|---|---|---|
| | | | Example 1 | Example 2 | Example 3 | Example 1 | Example 4 |
| Carbon | Addition of Surface Active Agent A | | — | — | — | Yes | — |
| black | Addition of Surface Active Agent B | | — | — | — | — | Yes |
| slurry | D90 in units of μm | | — | — | 10.3 | 1.9 | 4.9 |
| Masterbatch | Parts by | Natural rubber latex (dry rubber content) | — | — | 100 | 100 | 100 |
| | mass | Solid natural rubber | 100 | 100 | — | — | — |
| | | Carbon black | 30 | 30 | 30 | 30 | 30 |
| | Addition of Surface Active Agent A | | — | Yes | — | — | — |
| Nonproductive | Parts by | Masterbatch | 130 | 130 | 130 | 130 | 130 |
| mixing and | mass | Carbon black | 18 | 18 | 18 | 18 | 18 |
| productive | | Zinc oxide | 1 | 1 | 1 | 1 | 1 |
| mixing | | Stearic acid | 2 | 2 | 2 | 2 | 2 |
| | | Wax | 1 | 1 | 1 | 1 | 1 |
| | | Antioxidant A | 2 | 2 | 2 | 2 | 2 |
| | | Antioxidant B | 1 | 1 | 1 | 1 | 1 |
| | | Sulfur | 2 | 2 | 2 | 2 | 2 |
| | | Vulcanization accelerator | 1 | 1 | 1 | 1 | 1 |
| Vulcanized | Properties | tanδ | 100 | 102 | 96 | 92 | 94 |
| rubber | | Tensile strength | 100 | 98 | 101 | 106 | 102 |

At the vulcanized rubbers of Comparative Example 4 and Working Example 1, at which carbon black slurries were prepared with addition of surface active agent, the tan δ was lower, and the tensile strength was higher, than the vulcanized rubber at Comparative Example 3, at which the carbon black slurry was prepared without addition of surface active agent. This is thought to be due to the fact because the D90 values of the carbon black slurries at Comparative Example 4 and Working Example 1 were less than the D90 value at Comparative Example 3, this made it possible for the surface active agent to improve carbon black dispersion.

At the vulcanized rubber of Working Example 1, at which Surface Active Agent A was used to prepare the carbon black slurry, the tan δ was lower, and the tensile strength was higher, than the vulcanized rubber at Comparative Example 4, at which Surface Active Agent B was used to prepare the carbon black slurry. This is thought to be due to the fact because the D90 value of the carbon black slurry at Working Example 1 was less than the D90 value at Comparative Example 4, this made it possible for Surface Active Agent A to cause carbon black to be dispersed to an even higher degree.

1. A masterbatch manufacturing method comprising:
an operation in which carbon black is dispersed in dispersion medium in presence of a surface active agent having an aromatic ring to prepare a carbon black slurry;
an operation in which at least the carbon black slurry and a rubber latex are mixed to prepare a liquid mixture; and
an operation in which the liquid mixture is coagulated.

2. The masterbatch manufacturing method according to claim 1 wherein the aromatic ring is one among a plurality of intramolecular aromatic rings possessed by the surface active agent.

3. The masterbatch manufacturing method according to claim 1 wherein the surface active agent is a sodium salt of a β-naphthalene sulfonic acid-formaldehyde condensate.

4. The masterbatch manufacturing method according to claim 1 wherein the surface active agent is an anionic surface active agent.

5. The masterbatch manufacturing method according to claim 1 wherein, at the operation in which the carbon black slurry is prepared, the surface active agent is present in an amount that is not less than 0.1 part by mass but not greater than 5 parts by mass per 100 parts by mass of the dispersion medium.

6. The masterbatch manufacturing method according to claim 1 wherein the carbon black is present in an amount that is not less than 1 mass % but not greater than 30 mass % per 100 mass % of the carbon black slurry.

7. The masterbatch manufacturing method according to claim 1 wherein the rubber latex is natural rubber latex.

8. The masterbatch manufacturing method according to claim 1 wherein
the rubber latex is natural rubber latex; and
at the operation in which the liquid mixture is prepared, the carbon black is present in the carbon black slurry in an amount that is not less than 1 part by mass but not greater than 80 parts by mass per 100 parts by mass of dry rubber content in the natural rubber latex.

9. The masterbatch manufacturing method according to claim 1 further comprising an operation in which a coagulum obtained at the operation in which the liquid mixture is coagulated is dewatered.

10. The masterbatch manufacturing method according to claim 1 further comprising an operation in which an extruder is used to dewater a coagulum obtained at the operation in which the liquid mixture is coagulated.

11. The masterbatch manufacturing method according to claim 1 wherein, at the carbon black slurry, a (volume-based) particle diameter corresponding to 90% at an integrated particle diameter distribution of the carbon black is not less than 0.5 μm but not greater than 4.0 μm.

12. A tire manufacturing method comprising:
an operation in which a masterbatch is prepared by the masterbatch manufacturing method according to claim 1;
an operation in which the masterbatch is used to prepare a rubber composition; and
an operation in which the rubber composition is used to prepare an unvulcanized tire.

13. The tire manufacturing method according to claim 12 wherein
the operation in which the rubber composition is prepared comprises kneading at least the masterbatch and a compounding ingredient to prepare a rubber mixture, and kneading at least the rubber mixture and a vulcanizing agent to obtain the rubber composition.

14. The tire manufacturing method according to claim 12 wherein
the operation in which the unvulcanized tire is fabricated comprises fabrication of a tire member comprising the rubber composition, and fabrication of the unvulcanized tire that comprises the tire member.
